(19) United States
(12) Patent Application Publication
(10) Pub. No.: US 2014/0227578 A1
(43) Pub. Date: Aug. 14, 2014

(54) LITHIUM SOLID STATE BATTERY

(71) Applicant: Satoshi Yoshida, Susono-shi (JP)

(72) Inventor: Satoshi Yoshida, Susono-shi (JP)

(73) Assignee: TOYOTA JIDOSHA KABUSHIKI KAISHA, Toyota-shi, Aichi (JP)

(21) Appl. No.: 14/117,314

(22) PCT Filed: May 19, 2011
(86) PCT No.: PCT/JP2011/061564

§ 371 Date: Nov. 12, 2013

(51) Int. Cl. H01M 10/02; H01M 10/052

(52) U.S. Cl. CPC H01M 10/02; H01M 10/052
USPC 429/126

(57) ABSTRACT

The problem of the present invention is to provide a lithium solid state battery in which reaction resistance is reduced. The present invention solves the above-mentioned problem by providing a lithium solid state battery including a cathode active material layer containing a cathode active material, an anode active material layer containing an anode active material, and a solid electrolyte layer formed between the above-mentioned cathode active material layer and the above-mentioned anode active material layer, wherein a reaction inhibition portion including a Li ion conductive oxide having a B—O—Si structure is formed at an interface between the above-mentioned cathode active material and a high resistive layer-forming solid electrolyte material that reacts with the above-mentioned cathode active material to form the high resistive layer.

### TECHNICAL FIELD

The present invention relates to a lithium solid state battery in which reaction resistance is reduced.

### BACKGROUND ART

In accordance with a rapid spread of information relevant apparatuses and communication apparatuses such as a personal computer, a video camera and a portable telephone in recent years, the development of a battery to be used as a power source thereof has been emphasized. The development of a high-output and high-capacity battery for an electric automobile or a hybrid automobile has been advanced also in the automobile industry. A lithium battery has been presently noticed from the viewpoint of a high energy density among various kinds of batteries.

Liquid electrolyte containing a flammable organic solvent is used for a presently commercialized lithium battery, so that the installation of a safety device for restraining temperature rise during a short circuit and the improvement in structure and material for preventing the short circuit are necessary therefor. On the contrary, a lithium battery all-solidified by replacing the liquid electrolyte with a solid electrolyte layer is conceived to intend the simplification of the safety device and be excellent in production cost and productivity for the reason that the flammable organic solvent is not used in the battery.

The intention of improving performance of an all solid state battery while noticing an interface between a cathode active material and a solid electrolyte material has been conventionally attempted in the field of such an all solid state battery. For example, in Patent Literature 1, an all solid state battery, in which a cathode active material whose surface is coated with a reaction inhibition portion including a polyanion structure-containing compound is used, is disclosed. This intends to achieve higher durability of a battery by coating the surface of the cathode active material with the compound having a polyanion structure high in electrochemical stability to inhibit interface resistance between the cathode active material and a solid electrolyte material from increasing with time.

On the other hand, in Patent Literature 2, a method for producing a cathode active material for a lithium secondary battery, in which an oxide layer is formed on the surface of a lithium compound, is disclosed.

### CITATION LIST

### Patent Literatures

Patent Literature 1: Japanese Patent Application Publication (JP-A) No. 2010-135090
Patent Literature 2: Japanese Patent No. 4384380

### SUMMARY OF INVENTION

### Technical Problem

As Patent Literature 1, it is known that a Li complex oxide of an element with high electronegativity (the polyanion structure-containing compound) is high in a reaction inhibition effect. On the other hand, it was proved by the studies of the present inventors of the present invention that the Li complex oxide containing B and Si tends to be high in Li ion conductivity. However, the use of the reaction inhibition portion including the polyanion structure-containing compound of a B and Si complex system occasionally causes a reaction with the solid electrolyte material and increases reaction resistance of a lithium solid state battery. The present invention has been made in view of the above-mentioned actual circumstances, and the main object thereof is to provide a lithium solid state battery in which reaction resistance is reduced.

### Solution to Problem

In order to solve the above-mentioned problems, the present invention provides a lithium solid state battery comprising a cathode active material layer containing a cathode active material, an anode active material layer containing an anode active material, and a solid electrolyte layer formed between the above-mentioned cathode active material layer and the above-mentioned anode active material layer, wherein a reaction inhibition portion including a Li ion conductive oxide having a B—O—Si structure is formed at an interface between the above-mentioned cathode active material and a high resistive layer-forming solid electrolyte material that reacts with the above-mentioned cathode active material to form a high resistive layer.

According to the present invention, the reaction inhibition portion includes a Li ion conductive oxide having a B—O—Si structure, so that the lithium solid state battery in which reaction resistance is reduced may be obtained.

In the above-mentioned invention, the above-mentioned Li ion conductive oxide preferably has the above-mentioned B—O—Si structure as the main component. The reason therefor is to allow the effect of the present invention to be further performed.

In the above-mentioned invention, the above-mentioned cathode active material layer preferably contains the above-mentioned high resistive layer-forming solid electrolyte material. The reason therefor is to allow Li ion conductivity of the cathode active material layer to be improved.

In the above-mentioned invention, the above-mentioned solid electrolyte layer preferably contains the above-mentioned high resistive layer-forming solid electrolyte material. The reason therefor is to allow the lithium solid state battery excellent in Li ion conductivity.

In the above-mentioned invention, the above-mentioned reaction inhibition portion is preferably formed so as to cover the surface of the above-mentioned cathode active material. The reason therefor is that the cathode active material is so hard as compared with the high resistive layer-forming solid electrolyte material that the covered reaction inhibition portion is peeled off with difficulty.

In the above-mentioned invention, the above-mentioned high resistive layer-forming solid electrolyte material is preferably a sulfide solid electrolyte material. The reason therefor is that the sulfide solid electrolyte material is so high in Li ion conductivity as to allow higher output of the battery to be intended.

In the above-mentioned invention, the above-mentioned cathode active material is preferably an oxide cathode active material. The reason therefor is to allow the lithium solid state battery high in energy density.

### Advantageous Effects of Invention

The present invention produces the effect such as to allow reaction resistance of the lithium solid state battery to be reduced.

### BRIEF DESCRIPTION OF DRAWINGS

FIG. 1 is a schematic cross-sectional view showing an example of a power generating element of a lithium solid state battery of the present invention.

FIGS. 2A to 2D are schematic cross-sectional views explaining reaction inhibition portions in the present invention.

FIGS. 3A to 3D are schematic cross-sectional views explaining reaction inhibition portions in the present invention.

FIG. 4 is an R-EELS spectrum of a B K loss edge in a reaction inhibition portion produced in Examples 1 to 3 and Comparative Example 1.

FIG. 5 is an R-EELS spectrum of a B K loss edge in a reference material.

### DESCRIPTION OF EMBODIMENTS

A solid state battery of the present invention is hereinafter described in detail.

An all solid state battery of the present invention is a lithium solid state battery comprising a cathode active material layer containing a cathode active material, an anode active material layer containing an anode active material, and a solid electrolyte layer formed between the above-mentioned cathode active material layer and the above-mentioned anode active material layer, wherein a reaction inhibition portion including a Li ion conductive oxide having a B—O—Si structure is formed at an interface between the above-mentioned cathode active material and a high resistive layer-forming solid electrolyte material that reacts with the above-mentioned cathode active material to form a high resistive layer.

According to the present invention, the reaction inhibition portion includes a Li ion conductive oxide having a B—O—Si structure, so that the lithium solid state battery in which reaction resistance is reduced may be obtained. The reason therefor is conceived to be that the reaction inhibition portion has a B—O—Si structure, so that a covalent bond network spreads and thereby stability against the high resistive layer-forming solid electrolyte material increases. Also, in the present invention, the formation of the reaction inhibition portion at an interface between the cathode active material and the high resistive layer-forming solid electrolyte material allows interface resistance between the cathode active material and the high resistive layer-forming solid electrolyte material to be inhibited from increasing.

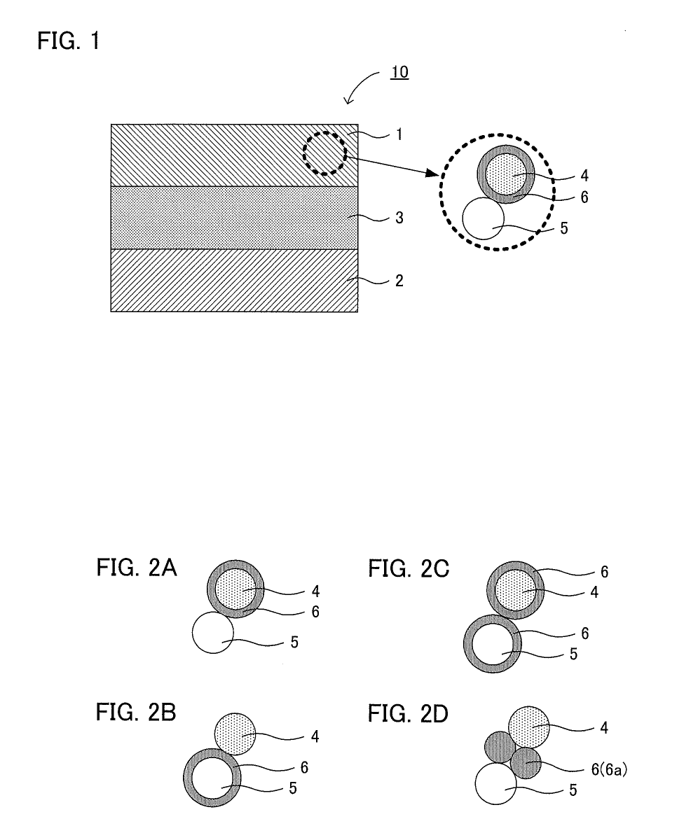

FIG. 1 is a schematic cross-sectional view showing an example of a power generating element of the lithium solid state battery of the present invention. A power generating element 10 of the lithium solid state battery shown in FIG. 1 comprises a cathode active material layer 1, an anode active material layer 2, and a solid electrolyte layer 3 formed between the cathode active material layer 1 and the anode active material layer 2. In addition, the cathode active material layer 1 includes a cathode active material 4, a high resistive layer-forming solid electrolyte material 5 that reacts with the cathode active material 4 to form the high resistive layer, and a reaction inhibition portion 6 formed at an interface between the cathode active material 4 and the high resistive layer-forming solid electrolyte material 5. In FIG. 1, the reaction inhibition portion 6 is formed so as to cover the surface of the cathode active material 4, and includes a Li ion conductive oxide having a B—O—Si structure.

The lithium solid state battery of the present invention is hereinafter described in each constitution.

1. Cathode Active Material Layer

First, the cathode active material layer in the present invention is described. The cathode active material layer in the present invention is a layer containing at least the cathode active material, and may further contain at least one of a solid electrolyte material, a conductive material and a binder as required. In particular, in the present invention, the solid electrolyte material contained in the cathode active material layer is preferably the high resistive layer-forming solid electrolyte material. The reason therefor is to allow Li ion conductivity of the cathode active material layer to be improved. Also, in the present invention, in the case where the cathode active material layer contains both the cathode active material and the high resistive layer-forming solid electrolyte material, the reaction inhibition portion including a Li ion conductive oxide having a B—O—Si structure is ordinarily formed in the cathode active material layer.

(1) Cathode Active Material

The cathode active material used for the present invention occludes and releases a Li ion. Also, the above-mentioned cathode active material ordinarily reacts with the after-mentioned solid electrolyte material (the high resistive layer-forming solid electrolyte material) to form the high resistive layer. Incidentally, the formation of the high resistive layer may be confirmed by a transmission electron microscope (TEM) and an energy-dispersive X-ray spectroscopy (EDX) or the like.

The cathode active material used for the present invention is not particularly limited if the material may react with the high resistive layer-forming solid electrolyte material to form the high resistive layer, but examples thereof include an oxide cathode active material. The use of the oxide cathode active material allows the lithium solid state battery high in energy density. Examples of the oxide cathode active material used for the present invention include an oxide active material represented by a general formula LiₓM_{y}O_{z} (M is a transition metallic element, x=0.02 to 2.2, y=1 to 2 and z=1.4 to 4). In the above-mentioned general formula, M is preferably at least one kind selected from the group consisting of Co, Mn, Ni, V and Fe, and more preferably at least one kind selected from the group consisting of Co, Ni and Mn. Specific examples of such an oxide active material include rock salt bed type active materials such as LiCoO₂, LiMnO₂, LiNiO₂, LiVO₂ and LiNi_{1/3}Co_{1/3}Mn_{1/3}O₂, and spinel type active materials such as LiMn₂O₄ and Li(Ni_{0.5}Mn_{1.5})O₄. Also, examples of the oxide active material except the above-mentioned general formula LiₓM_{y}O_{z} include olivine-type active materials such as LiFePO₄ and LiMnPO₄, and Si-containing active materials such as Li₂FeSiO₄ and Li₂MnSiO₄.

Examples of the shape of the cathode active material include a particulate shape, preferably a perfectly spherical shape or an elliptically spherical shape, above all. Also, in the case where the cathode active material is in a particulate shape, the average particle diameter thereof (D₅₀) is, for example, preferably within a range of 0.1 μm to 50 μm. Incidentally, the above-mentioned average particle diameter may be determined by a granulometer, for example. Also, the content of the cathode active material in the cathode active material layer is, for example, preferably within a range of 10% by weight to 99% by weight, and more preferably within a range of 20% by weight to 90% by weight.

(2) High Resistive Layer-Forming Solid Electrolyte Material

In the present invention, the cathode active material layer preferably contains the high resistive layer-forming solid electrolyte material. The reason therefor is to allow Li ion conductivity of the cathode active material layer to be improved. Also, the high resistive layer-forming solid electrolyte material used for the present invention ordinarily reacts with the above-mentioned cathode active material to form the high resistive layer. Incidentally, the formation of the high resistive layer may be confirmed by a transmission electron microscope (TEM) and an energy-dispersive X-ray spectroscopy (EDX) or the like.

Examples of the high resistive layer-forming solid electrolyte material used for the present invention include a sulfide solid electrolyte material and an oxide based solid electrolyte material, and preferably a sulfide solid electrolyte material, above all. The reason therefor is that the sulfide solid electrolyte material is so high in Li ion conductivity as to allow Li ion conductivity of the cathode active material layer to be improved and allow higher output of the battery to be intended. On the other hand, it is conceived that the sulfide solid electrolyte material is so low in stability as compared with the oxide based solid electrolyte material that reaction resistance increases. On the contrary, in the present invention, it is conceived that the reaction inhibition portion includes a Li ion conductive oxide having a B—O—Si structure, so that reaction resistance may be reduced. Accordingly, it is conceived that the use of the sulfide solid electrolyte material allows the reduction of reaction resistance to be intended while improving Li ion conductivity.

Examples of the sulfide solid electrolyte material used for the present invention include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (“m” and “n” are positive numbers; Z is any of Ge, Zn and Ga.) Li₂S—GeS₂, Li₂S—SiS₂—Li₃PO₄, and Li₂S—SiS₂—LiₓMO_{y} (“x” and “y” are positive numbers; M is any of P, Si, Ge, B, Al, Ga and In). Incidentally, the description of the above-mentioned “Li₂S—P₂S₅” signifies the sulfide solid electrolyte material obtained by using a raw material composition containing Li₂S and P₂S₅, and other descriptions signify similarly.

Also, in the case where the sulfide solid electrolyte material is obtained by using a raw material composition containing Li₂S and P₂S₅, the ratio of Li₂S to the total of Li₂S and P₂S₅ is, for example, preferably within a range of 70 mol % to 80 mol %, more preferably within a range of 72 mol % to 78 mol %, and far more preferably within a range of 74 mol % to 76 mol %. The reason therefor is to allow the sulfide solid electrolyte material having an ortho-composition or a composition in the neighborhood of it and allow the sulfide solid electrolyte material with high chemical stability. Here, ortho generally signifies oxo acid which is the highest in degree of hydration among oxo acids obtained by hydrating the same oxide. In the present invention, a crystal composition to which Li₂S is added most among sulfides is called an ortho-composition. Li₃PS₄ corresponds to the ortho-composition in the Li₂S—P₂S₅ system. In the case of an Li₂S—P₂S₅-based sulfide solid electrolyte material, the ratio of Li₂S and P₂S₅ such as to allow the ortho-composition is Li₂S:P₂S₅=75:25 on a molar basis. Incidentally, also in the case of using Al₂S₃ and B₂S₃ instead of P₂S₅ in the above-mentioned raw material composition, the preferable range is the same. Li₃AlS₃ corresponds to the ortho-composition in the Li₂S—Al₂S₃ system and Li₃BS₃ corresponds to the ortho-composition in the Li₂S—B₂S₃ system.

Also, in the case where the sulfide solid electrolyte material is obtained by using a raw material composition containing Li₂S and SiS₂, the ratio of Li₂S to the total of Li₂S and SiS₂ is, for example, preferably within a range of 60 mol % to 72 mol %, more preferably within a range of 62 mol % to 70 mol %, and far more preferably within a range of 64 mol % to 68 mol %. The reason therefor is to allow the sulfide solid electrolyte material having an ortho-composition or a composition in the neighborhood of it and allow the sulfide solid electrolyte material with high chemical stability. Li₄SiS₄ corresponds to the ortho-composition in the Li₂S—SiS₂ system. In the case of an Li₂S—SiS₂-based sulfide solid electrolyte material, the ratio of Li₂S and SiS₂ such as to allow the ortho-composition is Li₂S:SiS₂=66.6:33.3 on a molar basis. Incidentally, also in the case of using GeS₂ instead of SiS₂ in the above-mentioned raw material composition, the preferable range is the same. Li₄GeS₄ corresponds to the ortho-composition in the Li₂S—GeS₂ system.

Also, in the case where the sulfide solid electrolyte material is obtained by using a raw material composition containing LiX (X=Cl, Br and I), the ratio of LiX is, for example, preferably within a range of 1 mol % to 60 mol %, more preferably within a range of 5 mol % to 50 mol %, and far more, preferably within a range of 10 mol % to 40 mol %.

Also, the sulfide solid electrolyte material may be sulfide glass, crystallized sulfide glass, or a crystalline material (a material obtained by a solid phase method).

Incidentally, in the present invention, the oxide based solid electrolyte material may be also used as the high resistive layer-forming solid electrolyte material.

Also, in the present invention, the high resistive layer-forming solid electrolyte material preferably has cross-linking chalcogen. The reason therefor is that the high resistive layer-forming solid electrolyte material is so high in Li ion conductivity as to allow Li ion conductivity of the cathode active material layer to be improved and allow higher output of the battery to be intended. On the other hand, it is conceived that the solid electrolyte material having cross-linking chalcogen (the cross-linking chalcogen-containing solid electrolyte material) is so relatively low in electrochemical stability of cross-linking chalcogen that reaction resistance increases. On the contrary, in the present invention, it is conceived that the reaction inhibition portion includes a Li ion conductive oxide having a B—O—Si structure, so that reaction resistance may be reduced. Accordingly, it is conceived that the use of the cross-linking chalcogen-containing solid electrolyte material allows the reduction of reaction resistance to be intended while improving Li ion conductivity.

In the present invention, the above-mentioned cross-linking chalcogen is preferably cross-linking sulfur (—S—) or cross-linking oxygen (—O—), and more preferably cross-linking sulfur. The reason therefor is to allow the solid electrolyte material excellent in Li ion conductivity. Examples of the solid electrolyte material having cross-linking sulfur include Li₇P₃S₁₁, 0.6Li₂S-0.4SiS₂ and 0.6Li₂S-0.4GeS₂ or the like. Here, the above-mentioned Li₇P₃S₁₁ is the solid electrolyte material having an S₃P—S—PS₃ structure and a PS₄ structure, and the S₃P—S—PS₃ structure has cross-linking sulfur. Thus, in the present invention, the high resistive layer-forming solid electrolyte material preferably has the S₃P—S—PS₃ structure. The reason therefor is to allow the effect of the present invention to be sufficiently performed. On the other hand, examples of the solid electrolyte material having cross-linking oxygen include 95 (0.6Li₂S-0.4SiS₂)-5Li₄SiO₄, 95 (0.67Li₂S-0.33P₂S₅)-5Li₃PO₄ and 95 (0.6Li₂S-0.4GeS₂)-5Li₃PO₄.

Also, in the case where the high resistive layer-forming solid electrolyte material is a material having no cross-linking chalcogen, specific examples thereof include Li_{1.3}Al_{0.3}Ti_{1.7} (PO₄)₃ᵣ Li_{1.3}Al_{0.3}Ge_{1.7} (PO₄)₃, 0.8Li₂S-0.2P₂S₅ and Li_{3.25}Ge_{0.25}P_{0.75}S₄.

Examples of the shape of the high resistive layer-forming solid electrolyte material include a particulate shape, preferably a perfectly spherical shape or an elliptically spherical shape, above all. Also, in the case where the high resistive layer-forming solid electrolyte material is in a particulate shape, the average particle diameter thereof (D₅₀) is not particularly limited but is, for example, preferably within a range of 0.1 μm to 50 μm. Incidentally, the above-mentioned average particle diameter may be determined by a granulometer, for example. Also, Li ion conductance at normal temperature of the high resistive layer-forming solid electrolyte material is, for example, preferably 1×10⁻⁴ S/cm or more, and more preferably 1×10⁻³ S/cm or more. Also, the content of the high resistive layer-forming solid electrolyte material in the cathode active material layer is, for example, preferably within a range of 1% by weight to 90% by weight, and more preferably within a range of 10% by weight to 80% by weight.

(3) Reaction Inhibition Portion

In the present invention, in the case where the cathode active material layer contains both the cathode active material and the high resistive layer-forming solid electrolyte material, ordinarily, the reaction inhibition portion including a Li ion conductive oxide having a B—O—Si structure is also formed in the cathode active material layer. The reason therefor is that the reaction inhibition portion needs to be formed at an interface between the cathode active material and the high resistive layer-forming solid electrolyte material. The reaction inhibition portion has the function of inhibiting a reaction between the cathode active material and the high resistive layer-forming solid electrolyte material, which is caused in using the battery. The B—O—Si structure of the reaction inhibition portion is so high in stability against the high resistive layer-forming solid electrolyte material as to allow reaction resistance to be reduced.

First, the Li ion conductive oxide composing the reaction inhibition portion is described. The Li ion conductive oxide in the present invention has the B—O—Si structure, and ordinarily contains Li, B, O and Si.

Examples of the B—O—Si structure contained in the Li ion conductive oxide include a structure shown in the following formula (1). Also, the Li ion conductive oxide may have at least the B—O—Si structure, and additionally may have an ortho-structure (an Li₄SiO₄ structure and an Li₃BO₃ structure) shown in the following formulae (2) and (3), an SiO₂ structure shown in the following formula (4), a B₂O₃ structure shown in the following formula (5), and a meta-structure (an Li₂SiO₃ structure and an LiBO₂ structure) shown in the following formulae (6) and (7).

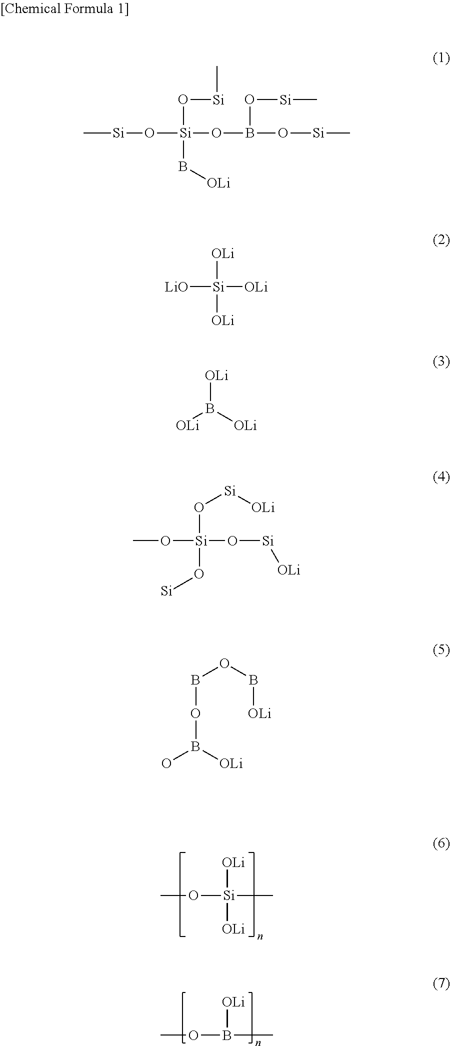

The ratio of the B—O—Si structure contained in the Li ion conductive oxide is not particularly limited if the ratio is such as to allow reaction resistance to be reduced, but in the present invention, the Li ion conductive oxide preferably has the B—O—Si structure as the main component. The reason therefor is to allow the effect of the present invention to be further performed. Here, ‘have the B—O—Si structure as the main component’ signifies that the ratio (A/B) of the B—O—Si structure (A) to all structures (B) contained in the Li ion conductive oxide is the largest as compared with the ratio (X/B) of each of the other structures (X) to all structures (B) contained in the Li ion conductive oxide. Here, all structures (B) contained in the Li ion conductive oxide may be regarded as the structures shown in the above-mentioned formulae (1) to (7), for example. Above all, the above-mentioned A/B is preferably 45 mol % or more, and more preferably 75 mol % or more. Incidentally, examples of a measuring method for the above-mentioned A/B include reflection-electron energy loss spectroscopy (R-EELS), TEM-EELS and XAFS. In particular, in the present invention, the Li ion conductive oxide preferably has only the B—O—Si structure. The reason therefor is to allow reaction resistance to be effectively reduced.

Also, the ratio (A/C) of the B—O—Si structure (A) to all structures containing B (boron) (C) contained in the Li ion conductive oxide is, for example, preferably 45 mol % or more, and more preferably 75 mol % or more. Here, examples of all structures containing B (boron) (C) contained in the Li ion conductive oxide include the B—O—Si structure, the Li₃BO₃ structure, the LiBO₂ structure and the B₂O₃ structure. Incidentally, the ratio of the 3-O—Si structure on a B basis contained in the Li ion conductive oxide may be measured by reflection-electron energy loss spectroscopy (R-EELS), for example. Specifically, the ratio is obtained by fitting an R-EELS spectrum of the Li ion conductive oxide composing the reaction inhibition portion with an R-EELS spectrum of a standard sample having any structure contained in the above-mentioned Li ion conductive oxide.

In the present invention, the content of the Li ion conductive oxide in the cathode active material layer is, for example, preferably within a range of 0.01% by weight to 20% by weight, and more preferably within a range of 0.1% by weight to 10% by weight.

Next, the form of the reaction inhibition portion in the cathode active material layer is described. In the present invention, in the case where the cathode active material layer contains the high resistive layer-forming solid electrolyte material, the reaction inhibition portion including the Li ion conductive oxide having the B—O—Si structure is ordinarily formed in the cathode active material layer. As shown in FIGS. 2A to 2D, examples of the form of the reaction inhibition portion in this case include a form such that the reaction inhibition portion 6 is formed so as to cover the surface of the cathode active material 4 (FIG. 2A), a form such that the reaction inhibition portion 6 is formed so as to cover the surface of the high resistive layer-forming solid electrolyte material 5 (FIG. 2B), and a form such that the reaction inhibition portion 6 is formed so as to cover the surface of the cathode active material 4 and the high resistive layer-forming solid electrolyte material 5 (FIG. 2C). Above all, in the present invention, the reaction inhibition portion is preferably formed so as to cover the surface of the cathode active material. The reason therefor is that the cathode active material is so hard as compared with the high resistive layer-forming solid electrolyte material that the covered reaction inhibition portion is peeled off with difficulty.

Incidentally, as shown in FIG. 2D, also a mere mixture of the cathode active material, the high resistive layer-forming solid electrolyte material and the Li ion conductive oxide allows a Li ion conductive oxide 6a having the B—O—Si structure to be disposed at an interface between the cathode active material 4 and the high resistive layer-forming solid electrolyte material 5, and allows the reaction inhibition portion 6 to be formed. This case has the advantage that the production process of the cathode active material layer is simplified even though the effect of reducing reaction resistance is somewhat deteriorated.

Also, the thickness of the reaction inhibition portion, which covers the cathode active material or the high resistive layer-forming solid electrolyte material, is preferably a thickness such as not to cause these materials to react; for example, preferably within a range of 0.1 nm to 100 nm, and more preferably within a range of 1 nm to 20 nm. The reason therefor is that too small thickness of the reaction inhibition portion brings a possibility that the cathode active material and the high resistive layer-forming solid electrolyte material react, while too large thickness of the reaction inhibition portion brings a possibility that Li ion conductivity and electron conductivity deteriorate. Incidentally, examples of a measuring method for the thickness of the reaction inhibition portion include a transmission electron microscope (TEM). Also, the coverage factor of the reaction inhibition portion on the surface of the cathode active material or the high resistive layer-forming solid electrolyte material is preferably high from the viewpoint of reducing reaction resistance; specifically, preferably 50% or more, and more preferably 80% or more. Also, the reaction inhibition portion may coat the whole surface of the cathode active material or the high resistive layer-forming solid electrolyte material. Incidentally, examples of a measuring method for the coverage factor of the reaction inhibition portion include a transmission electron microscope (TEM) and an X-ray photoelectron spectroscopy (XPS).

A method for forming the reaction inhibition portion in the present invention is preferably selected properly in accordance with the above-mentioned form of the reaction inhibition portion. In the case of forming the reaction inhibition portion which covers the cathode active material, specific examples of the method for forming the reaction inhibition portion include a tumbling flow coating method (a sol-gel method) and spray dry.

In the method for forming the reaction inhibition portion by using a tumbling flow coating method, first, a mixed solution in which Li source, B source and Si source are dissolved in a solvent is stirred and hydrolyzed to thereby prepare a coating solution for forming the reaction inhibition portion. Next, the cathode active material is coated with the coating solution for forming the reaction inhibition portion by a tumbling flow coating method. In addition, the reaction inhibition portion which covers the surface of the cathode active material is formed by burning the cathode active material whose surface is coated with the coating solution for forming the reaction inhibition portion. Here, examples of the Li source include Li salt or Li alkoxide; specifically, lithium acetate (CH₃COOLi) may be used. Examples of the B source and Si source include such as to have an OH group at the end or such as to hydrolyze into a hydroxide; specifically, boric acid (H₃BO₃) and tetraethoxysilane (Si(C₂H_{S}O)₄) may be used respectively. The solvent is not particularly limited if the solvent is an organic solvent such as to allow the Li source, B source and Si source to be dissolved, but examples thereof include ethanol. Incidentally, the above-mentioned solvent is preferably an anhydrous solvent. Also, in the present invention, the reaction inhibition portion including the Li ion conductive oxide having the B—O—Si structure may be formed by controlling the hydrolyzing conditions and burning conditions.

The hydrolysis is preferably completed sufficiently. The hydrolysis temperature is, for example, preferably within a range of 5° C. to 30° C. Also, the hydrolysis time (stirring time) is preferably adjusted in accordance with the hydrolysis temperature. For example, in the case where the hydrolysis temperature is 10° C., the hydrolysis time is preferably 51 hours or more, and in the case where the hydrolysis temperature is 19.1° C., the hydrolysis time is preferably 23 hours or more. Incidentally, in the present invention, the sufficient completion of the hydrolysis may be confirmed in such a manner that a solution is cast on a flat board and a uniform film is formed in observing the formed film with a microscope. Incidentally, if the hydrolysis does not proceed, unevenness and an undried portion due to the remaining of alkoxide are caused on the film.

The burning temperature is, for example, preferably within a range of 300° C. to 450° C., and more preferably within a range of 350° C. to 400° C. Also, the burning time is, for example, preferably within a range of 1 hour to 10 hours. Also, the burning atmosphere is preferably in the presence of oxygen, and specific examples thereof include an air atmosphere and a pure oxygen atmosphere. Also, examples of the burning method include a method by using a burning furnace such as a muffle furnace.

(4) Cathode Active Material Layer

The cathode active material layer in the present invention may further contain a conductive material. The addition of the conductive material allows electrical conductivity of the cathode active material layer to be improved. Examples of the conductive material include acetylene black, Ketjen Black and carbon fiber. Also, the cathode active material layer in the present invention may further contain a binder. Examples of the binder include fluorine-containing binders such as PTFE and PVDF. Also, the thickness of the cathode active material layer varies with constitutions of an intended lithium solid state battery, and is preferably within a range of 0.1 μm to 1000 μm, for example.

2. Solid Electrolyte Layer

Next, the solid electrolyte layer in the present invention is described. The solid electrolyte layer in the present invention is a layer formed between the cathode active material layer and the anode active material layer, and a layer containing at least a solid electrolyte material. As described above, in the case where the cathode active material layer contains the high resistive layer-forming solid electrolyte material, the solid electrolyte material used for the solid electrolyte layer is not particularly limited but may be the high resistive layer-forming solid electrolyte material or a solid electrolyte material except therefor. On the other hand, in the case where the cathode active material layer does not contain the high resistive layer-forming solid electrolyte material, the solid electrolyte layer ordinarily contains the high resistive layer-forming solid electrolyte material. In particular, in the present invention, both the cathode active material layer and the solid electrolyte layer preferably contain the high resistive layer-forming solid electrolyte material. The reason therefor is to allow the effect of the present invention to be sufficiently produced. Also, the solid electrolyte material used for the solid electrolyte layer is preferably only the high resistive layer-forming solid electrolyte material.

Incidentally, the high resistive layer-forming solid electrolyte material is the same as the contents described in the above-mentioned ‘1. Cathode active material layer’. Also, the same material as a solid electrolyte material used for a general lithium solid state battery may be used for a solid electrolyte material except the high resistive layer-forming solid electrolyte material.

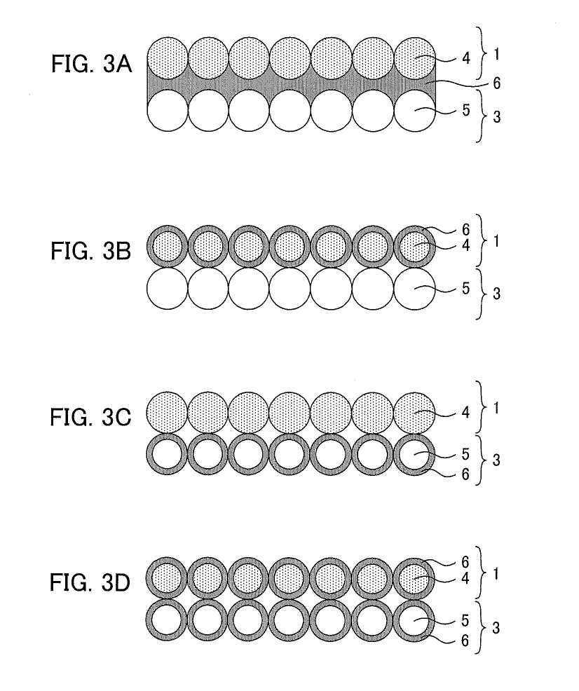

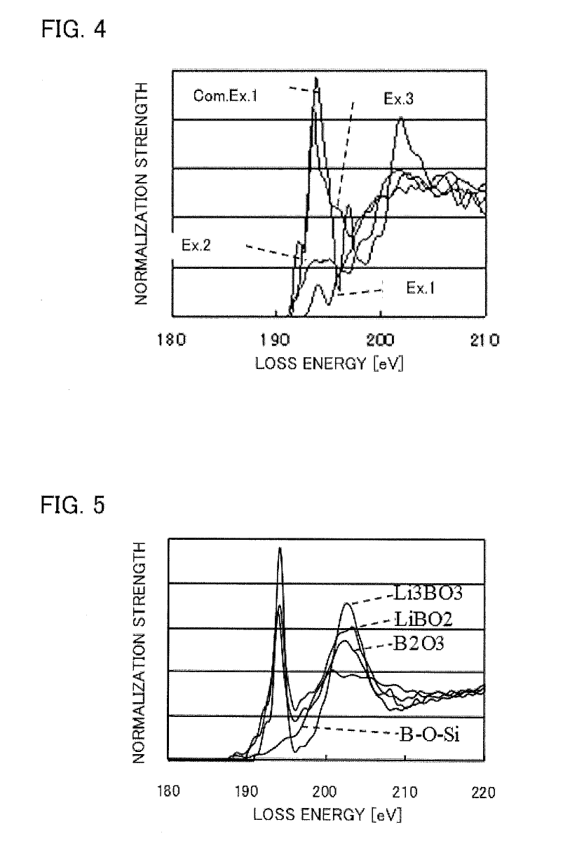

In the present invention, in the case where the solid electrolyte layer contains the high resistive layer-forming solid electrolyte material, the reaction inhibition portion including the Li ion conductive oxide having the above-mentioned B—O—Si structure is ordinarily formed in the cathode active material layer, in the solid electrolyte layer, or at an interface between the cathode active material layer and the solid electrolyte layer. As shown in FIGS. 3A to 3D, examples of the form of the reaction inhibition portion in this case include a form such that the reaction inhibition portion 6 is formed at an interface between the cathode active material layer 1 containing the cathode active material 4 and the solid electrolyte layer 3 containing the high resistive layer-forming solid electrolyte material 5 (FIG. 3A), a form such that the reaction inhibition portion 6 is formed so as to cover the surface of the cathode active material 4 (FIG. 3B), a form such that the reaction inhibition portion 6 is formed so as to cover the surface of the high resistive layer-forming solid electrolyte material 5 (FIG. 3C), and a form such that the reaction inhibition portion 6 is formed so as to cover the surface of the cathode active material 4 and the high resistive layer-forming solid electrolyte material 5 (FIG. 3D). Above all, in the present invention, the reaction inhibition portion is preferably formed so as to cover the surface of the cathode active material. The reason therefor is that the cathode active material is so hard as compared with the high resistive layer-forming solid electrolyte material that the covered reaction inhibition portion is peeled off with difficulty.

The content of the solid electrolyte material in the solid electrolyte layer is, for example, preferably within a range of 10% by weight to 100% by weight, and more preferably within a range of 50% by weight to 100% by weight. Also, the solid electrolyte layer may further contain a binder. Examples of the binder include fluorine-containing binders such as PTFE and PVDF. Also, the thickness of the solid electrolyte layer is not particularly limited but is, for example, preferably within a range of 0.1 μm to 1000 μm, and more preferably within a range of 0.1 μm to 300 μm

3. Anode Active Material Layer

Next, the anode active material layer in the present invention is described. The anode active material layer in the present invention is a layer containing at least the anode active material, and may further contain at least one of a solid electrolyte material, a conductive material and a binder as required. Examples of the anode active material include a metal active material and a carbon active material. Examples of the metal active material include Li alloy, In, Al, Si, and Sn. On the other hand, examples of the carbon active material include graphite such as mesocarbon microbeads (MCMB) and high orientation property graphite (HOPG), and amorphous carbon such as hard carbon and soft carbon. Incidentally, SiC and the like may be also used as the anode active material. The content of the anode active material in the anode active material layer is, for example, preferably within a range of 10% by weight to 99% by weight, and more preferably within a range of 20% by weight to 90% by weight. Incidentally, the solid electrolyte material, the conductive material and the binder used for the anode active material layer are the same as the above-mentioned case in the cathode active material layer. Also, the thickness of the anode active material layer varies with constitutions of an intended lithium solid state battery, and is preferably within a range of 0.1 μm to 1000 μm, for example.

4. Other Constitutions

The lithium solid state battery of the present invention comprises at least the above-mentioned cathode active material layer, anode active material layer and solid electrolyte layer, ordinarily further comprising a cathode current collector that collects the cathode active material layer and an anode current collector that collects the anode active material layer. Examples of a material for the cathode current collector include SUS, aluminum, nickel, iron, titanium and carbon. On the other hand, examples of a material for the anode current collector include SUS, copper, nickel and carbon. Also, the thickness and shape of the cathode current collector and the anode current collector are preferably selected properly in accordance with factors such as the uses of the lithium solid state battery. Also, a battery case of a general lithium solid state battery may be used for a battery case used for the present invention. Examples of the battery case include a battery case made of SUS.

5. Lithium Solid State Battery

The lithium solid state battery of the present invention may be a primary battery or a secondary battery, and preferably a secondary battery among them. The reason therefor is to be repeatedly charged and discharged and be useful as a car-mounted battery, for example. Examples of the shape of the lithium solid state battery of the present invention include a coin shape, a laminate shape, a cylindrical shape and a rectangular shape. Also, a producing method for the lithium solid state battery of the present invention is not particularly limited if the method is such as to allow the above-mentioned lithium solid state battery, but the same method as a producing method for a general lithium solid state battery may be used.

Incidentally, the present invention is not limited to the above-mentioned embodiments. The above-mentioned embodiments are exemplification, and any is included in the technical scope of the present invention if it includes substantially the same constitution as the technical idea described in the claim of the present invention and offers similar operation and effect thereto.

### EXAMPLES

The present invention is described more specifically while showing examples hereinafter.

### Example 1

### Preparation of Coating Solution for Forming Reaction Inhibition Portion

First, boric acid (H₃BO₃, manufactured by Wako Pure Chemical Industries, Ltd.), tetraethoxysilane (Si(C₂H_{S}O)₄, manufactured by Kojundo Chemical Lab. Co., Ltd.) and lithium acetate (CH₃COOLi, manufactured by Wako Pure Chemical Industries, Ltd.) were dissolved and mixed in anhydrous ethanol (C₂H₅OH, manufactured by Wako Pure Chemical Industries, Ltd.) so as to become a concentration of 0.066 mol/L, 0.066 mol/L and 0.463 mol/L, respectively. Next, this mixed solution was stirred at a temperature of 19.1° C. for 24 hours to thereby hydrolyze and then prepare a coating solution for forming a reaction inhibition portion.

(Production of Cathode Active Material Whose Surface is Coated with Reaction Inhibition Portion)

The above-mentioned coating solution for forming a reaction inhibition portion was coated on 1.25 kg of a cathode active material (LiNi_{1/3}CO_{1/3}Mn_{1/3}O₂) by using a tumbling flow bed coating apparatus (manufactured by Powrex Corp.). In addition, the cathode active material whose surface is coated with the above-mentioned coating solution for forming a reaction inhibition portion was burned in an air atmosphere at a temperature of 400° C. for 1 hour by using a muffle furnace to thereby produce the cathode active material whose surface is coated with the reaction inhibition portion.

(Synthesis of High Resistive Layer-Forming Solid Electrolyte Material)

First, lithium sulfide (Li₂S) and phosphorus pentasulfide (P₂S₅) were used as a starting material. These powders were weighed in a glove box under an Ar atmosphere (dew point: −70° C.) so as to become a molar ratio of Li₂S:P₂S₅=75:25, and mixed by an agate mortar to obtain a raw material composition. Next, 1 g of the obtained raw material composition was projected into a 45-ml zirconia pot, and zirconia ball (φ=10 mm, 10 pieces) was further projected thereinto to hermetically seal the pot completely (Ar atmosphere). This pot was mounted on a planetary ball milling machine (P7™ manufactured by FRITSCH JAPAN CO., LTD.) to perform mechanical milling for 40 hours at the number of rotating table revolutions of 370 rpm and then obtain a high resistive layer-forming solid electrolyte material (75Li₂S-25P₂S₅, sulfide glass).

(Production of Lithium Solid State Battery)

First, the above-mentioned cathode active material whose surface is coated with the reaction inhibition portion and 75Li₂S-25P₂S₅ were mixed at a weight ratio of 7:3 to obtain a cathode mix. Also, graphite (MF-6™ manufactured by Mitsubishi Chemical Corporation) and 75Li₂S-25P₂S₅ were mixed at a weight ratio of 5:5 to obtain an anode mix. Next, a power generating element 10 of a lithium solid state battery as shown in the above-mentioned FIG. 1 was produced by using a pressing machine. The above-mentioned cathode mix, the above-mentioned anode mix, and 75Li₂S-25P₂S₅ were used as a material composing a cathode active material layer 1, a material composing an anode active material layer 2, and a material composing a solid electrolyte layer 3, respectively. A lithium solid state battery was obtained by using this power generating element.

### Example 2

A lithium solid state battery was obtained in the same manner as Example 1 except for burning in an air atmosphere at a temperature of 350° C. for 10 hours in the production of the cathode active material whose surface is coated with the reaction inhibition portion.

### Example 3

A lithium solid state battery was obtained in the same manner as Example 1 except for burning in a pure oxygen atmosphere at a temperature of 350° C. for 5 hours in the production of the cathode active material whose surface is coated with the reaction inhibition portion.

### Comparative Example 1

A lithium solid state battery was obtained in the same manner as Example 1 except for hydrolyzing by stirring at a temperature of 10° C. for 21 hours in the preparation of the coating solution for forming the reaction inhibition portion, and burning in an air atmosphere at a temperature of 350° C. for 5 hours in the production of the cathode active material whose surface is coated with the reaction inhibition portion.

### [Evaluations]

(R-EELS Analysis)

The analysis by reflection-electron energy loss spectroscopy (R-EELS) was performed by using the cathode active materials whose surface were coated with the reaction inhibition portion, produced in Examples 1 to 3 and Comparative Example 1. First, an R-EELS spectrum of a B K loss edge in the reaction inhibition portion was measured, and an R-EELS spectrum of a B K loss edge in a reference material having each of the Li₃BO₃ structure, the LiBO₂ structure, the B₂O₃ structure and the 3-O—Si structure was measured. The results are shown in FIGS. 1 and 2A to 2D. Next, the R-EELS spectrum of the reaction inhibition portion was fitted with the R-EELS spectrum of a reference material to thereby perform peak separation, identify the structure of the reaction inhibition portion, and measure the structural ratio of the reaction inhibition portion. The results are shown in Table 1. Incidentally, in the R-EELS measurement, the apparatus conditions were analysis device: PHI4300™ revised scanning Auger electron spectroscopic apparatus manufactured by PerkinElmer Co., Ltd., EA125™ electrostatic hemispherical detector manufactured by Omicron Nano Technology Japan Inc., irradiation current: approximately 40 nA, beam diameter: approximately 8 μmφ, analysis area: the same as beam diameter (spot analysis) and incident angle: 45° with sample normal line, and the analysis conditions of B K loss edge (approximately 188 eV) core loss spectrum were acceleration voltage: 0.55 kV, energy capture range: 45.00 eV, energy sweep range: 300 eV to 400 eV (kinetic energy), 150 eV to 250 eV (loss energy), energy step size: 0.10 eV and signal integration time: 0.10 second×50 times.

(Reaction Resistance Measurement)

Reaction resistance measurement was performed by using the lithium solid state battery obtained in Examples 1 to 3 and Comparative Example 1. The reaction resistance of the battery was calculated by performing complex impedance measurement after adjusting electric potential of the lithium solid state battery to 3.7 V. Incidentally, the reaction resistance was calculated from a diameter of an arc of the impedance curve. The results are shown in Table 1.

TABLE 1

| | | | | | REAC- |
|---|---|---|---|---|---|
| | STRUCTURAL RATIO OF REACTION | | | | TION |
| | INHIBITION PORTION | | | | RESIS- |
| | Li₃BO₃ | LiBO₂ | B₂O₃ | B—O—Si | TANCE |
| | mol % | | | | Ω · cm² |
| EXAMPLE 1 | 0 | 0 | 0 | 100 | 102.3 |
| EXAMPLE 2 | 0 | 6.2 | 18.3 | 75.5 | 262.9 |
| EXAMPLE 3 | 0 | 22.2 | 30.9 | 46.9 | 371.7 |
| COMPARATIVE | 14.5 | 21 | 64.5 | 0 | >1000 |
| EXAMPLE 1 | | | | | |

As shown in Table 1, it was confirmed that the reaction resistance of the lithium solid state battery obtained in Examples 1 to 3 was substantially low as compared with the reaction resistance of the lithium solid state battery obtained in Comparative Example 1, and higher ratio of the B—O—Si structure in the reaction inhibition portion caused the reaction resistance to be reduced further. Therefore, it was suggested that the B—O—Si structure had the effect of reducing the reaction resistance.

### REFERENCE SIGNS LIST

1 Cathode active material layer
2 Anode active material layer
3 Solid electrolyte layer
4 Cathode active material
5 High resistive layer-forming solid electrolyte material
6 Reaction inhibition portion
10 Power generating element of lithium solid state battery

1-7. (canceled)

8. A lithium solid state battery comprising a cathode active material layer containing a cathode active material, an anode active material layer containing an anode active material, and a solid electrolyte layer formed between the cathode active material layer and the anode active material layer,
wherein a reaction inhibition portion comprising a Li ion conductive oxide having a B—O—Si structure as a main component is formed at an interface between the cathode active material and a high resistive layer-forming solid electrolyte material that reacts with the cathode active material to form a high resistive layer.

9. The lithium solid state battery according to claim 8, wherein the cathode active material layer contains the high resistive layer-forming solid electrolyte material.

10. The lithium solid state battery according claim 8, wherein the solid electrolyte layer contains the high resistive layer-forming solid electrolyte material.

11. The lithium solid state battery according to claim 8, wherein the reactive inhibition portion is formed so as to cover a surface of the cathode active material.

12. The lithium solid state battery according to claim 8, wherein the high resistive layer-forming solid electrolyte material is a sulfide solid electrolyte material.

13. The lithium solid state battery according to claim 8, wherein the cathode active material is an oxide cathode active material.
